(19) United States
(12) Patent Application Publication
(10) Pub. No.: US 2006/0050381 A1
(43) Pub. Date: Mar. 9, 2006

(54) Method and system for stereoscopic representation

(76) Inventor: Apostolos Konstantinidis, Athens (GR)

Correspondence Address: Webb Ziesenheim Logsdon;Orkin & Hanson, 700 Koppers Building, 436 Seventh Avenue, Pittsburgh, PA, 15219-1818, US

(21) Appl. No.: 10/516,902

(22) PCT Filed: Jun. 5, 2002
(86) PCT No.: PCT/GR03/00021

§ 371 Date: Dec. 3, 2004

(30) Foreign Application Priority Data
Jun. 5, 2002 (GB) 20020100265

(51) Int. Cl. G02B 27/22

(52) U.S. Cl. 359/462

(57) ABSTRACT

The invention discloses a method and a system used for stereoscopically representing a subject. According to the invention, the method records and captures the subject from two different points of view, and generates an image, which is in turn decomposed to two images and then sent to the dual output of a personal computer's graphic card.

The invention refers to a method and to a system used for stereoscopically representing a subject

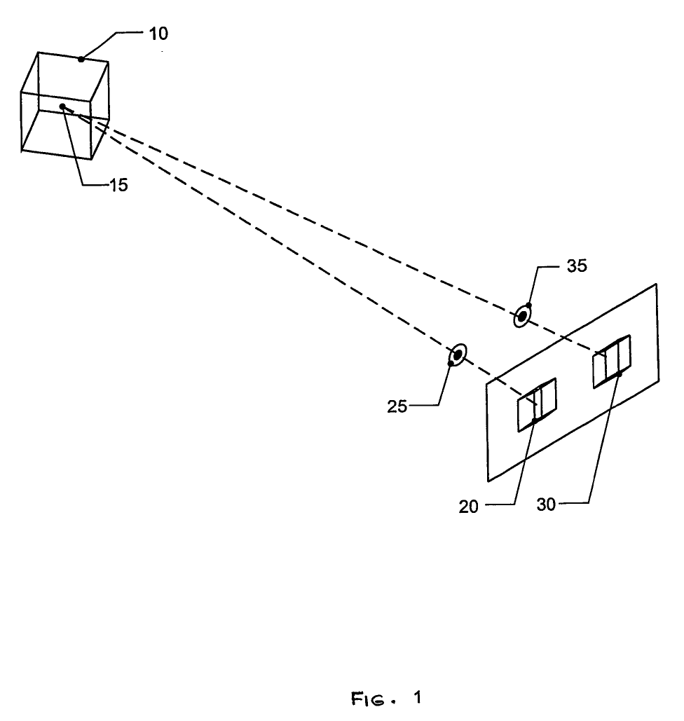

Generally, for the stereoscopic representation of a subject, it is required to have a) two rows of a sequence of pictures, taken at consecutive time, one from the position of the observer's left eye, and one from the observer's right eye (see FIG. 1), and b) the appropriate equipment for their projection.

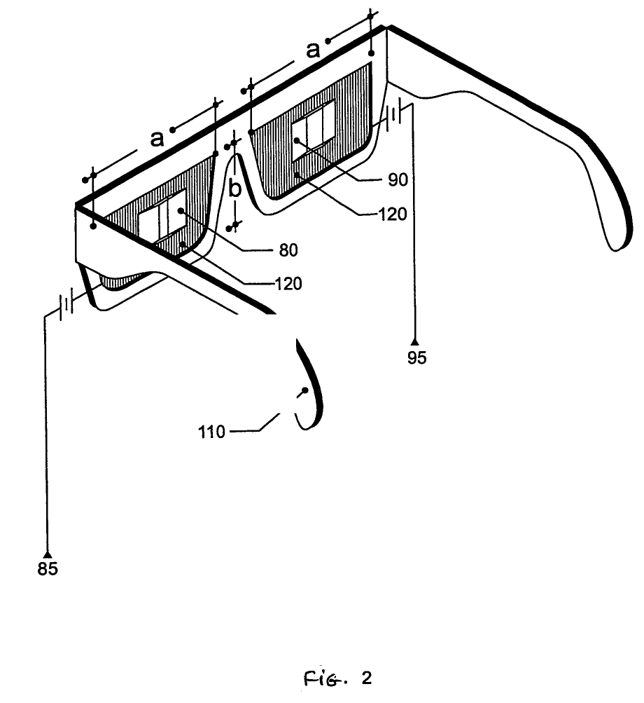

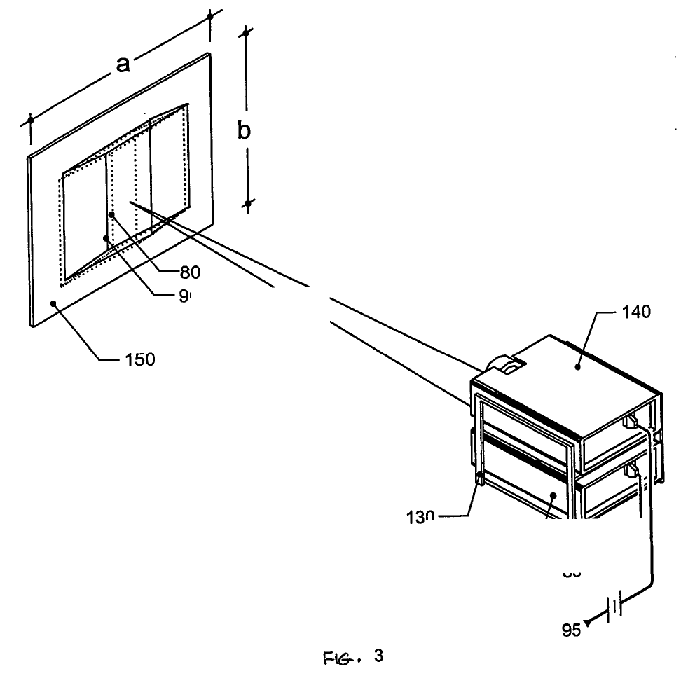

Stereoscopy is being differentiated in two modes: direct and indirect. In direct mode, every signal corresponding to an image is being directed to the appropriate display of the corresponding eye (see FIG. 2). In indirect mode (FIG. 3), the two signals—consisting of the images for the left and right eye—are being composed in a single image which is projected in a single screen, and the user receives the corresponding original images through a pair of glasses that perform the decomposition.

Indirect stereoscopy in turn, is being differentiated in active and passive stereoscopy. In the first one, the two signals are being swapped several times in a single second, and the user watches through the appropriate glasses each image alternately; once for the left eye and once for the right, whereas the glasses shutter each eye alternately with the same frequency. In passive stereoscopy, both signals are projected with opposite polarization (usually horizontal-vertical), and the user wears polarizing glasses to decompose the two signals in two different images.

Using the available technology in computers and projection systems, stereoscopic representation is being achieved through the projection of two signals, consisting of the images for the left and right eye. Up until now, in personal computers, the above process has been implemented using the main output of the PC's graphics card, where the two signals carrying the two images are coming out alternately, either line by line (interlaced) or image by image (page swapped). A splitter has been used to divide the two independent images, and divert them to the appropriate display device.

According to the current invention, no splitter is required to produce the same effect, thus saving the user from buying extra hardware, which is highly priced and reduces the quality of the final resulting effect.

The invention is specified in claim 1. Claims from 2 up to 7, describe additional parameters, which lead to more benefits.

The invention, according to claim 1, turns to advantage the capability that a personal computer's operating system has, in splitting an image in several ones, in cooperation with graphics cards equipped with two separate outputs. A software application has been developed to produce a high-resolution image, which is projected in multiple vertically or horizontally tiled monitors, without stereoscopic projection though.

An example of the invention, referencing FIGS. 1 to 5, is laid out beneath

The way of representing a stereoscopic subject is introduced in FIG. 1.

In FIGS. 2 and 3, active and passive stereoscopy is presented schematically.

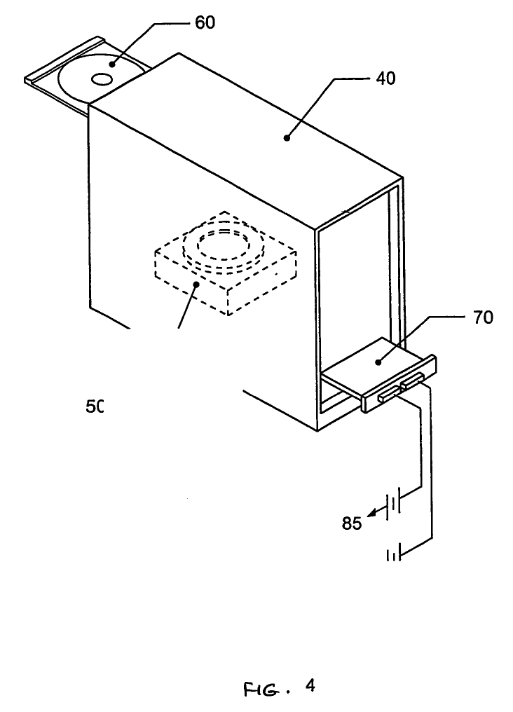

A personal computer required for the implementation of the invention is presented in FIG. 4.

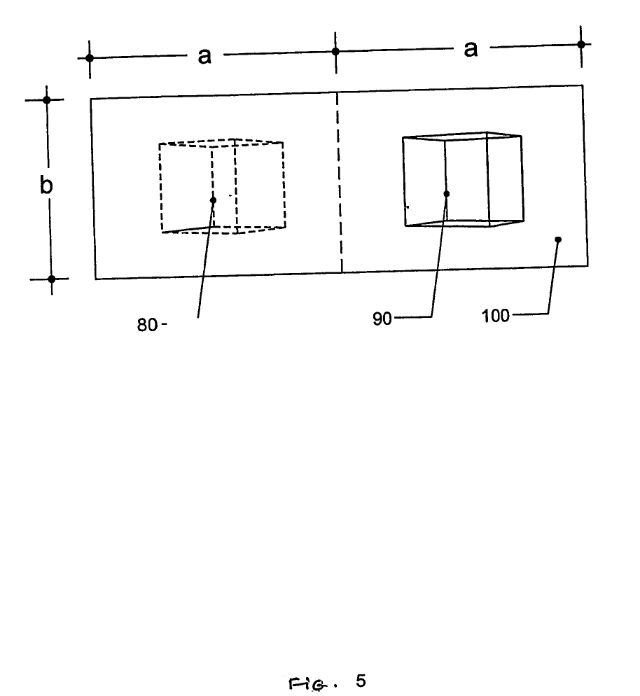

Finally, the method of producing the images, according to the current invention, is schematically introduced in FIG. 5.

For the stereoscopic representation of a subject (10), according to the current invention, nothing more than a simple personal computer (40), a common operating system (50), a graphic card with dual display (70) and the appropriate software (60) is being required. The one and united image (100) that the specific software creates, and which comprises from the two images (80, 90) homological to images (20, 30), is driven through two signals (85, 95) in a screen (120, 150), where the user may stereoscopically observe the subject. In the case of direct stereoscopy the images are driven in two displays (120), whereas in indirect stereoscopy the images are driven in a single display (150).

With the current invention, we are able to produce both direct and indirect stereoscopy. The picture generated by the personal computer (100) using the specific software (60) is integral, with resolution 2a×b where a and b is the resolution of the right and left displays (120, 150). The image corresponding to the left eye (80), is positioned in the half left part of the total image (100), and—similarly—the image corresponding to the right eye image (90) is placed on the other (right) half part (100). Using any modern graphic card which has dual output (70), and through the appropriate configuration in the Microsoft Windows operating system (50), the original image of resolution 2a×b is split in half (85,95) and redirected to the two outputs, which send these two signals (85,95) in the corresponding projection displays (120 or 150) of a×b resolution each.

The two images (20,30) can be either naturally captured by a camera, or technically generated by a computer from a virtual solid model. In both cases, the images are packed in a single file and stored in electronic media, through a specific file protocol (format). The current invention may be used for stereoscopic representation of sequenced image pairs of any type; static, rate filled and real timed. These pairs are either generated in a specific file format, or converted to it from commonly used video formats (e.g. avi). This allows us to create stereoscopic movie films for the cinema, either in video or DVD format. The two streams for the video may be either naturally shot using two cameras, or technically generated from virtual models in personal computers, as walkthrough animations.

Figure Explanation

(10) the subject to be represented stereoscopically

(15) the spot where the two cameras capturing the subject focus/target to

(20) the picture captured from the position of the left eye

(25) the camera for the left eye

(30) the picture captured from the position of the right eye

(35) the camera for the right eye

(40) common personal computer

(50) Microsoft Windows operating system

(60) software

(70) graphic card with dual output

(80) left eye image

(85) signal of left eye image

(90) right eye image

(95) signal of right eye image

(100) The integral picture, generated by the specific software

(110) glass type dual projection system

(120) small size-high resolution monitor (one for each eye)

(130) Converge case, for system of twin projectors

(140) Projector, for computer signal output

(150) Monitor for simultaneous projection of two images

1-7. (canceled)

8. A system for stereoscopic representation of a subject, comprising a computer in communication with a graphic card having at least two outputs, wherein two images capturing the subject from two different positions are directed in the two outputs of the graphic card.

9. The system of claim 8, wherein the two images are composed in a single image, which is electronically stored, decomposed to the two original images and directed in the two outputs of the graphic card.

10. The system of claim 9, wherein the image resulting after the composition has double resolution compared to the size of the original two images.

11. The system of claim 9, further comprising software configured to perform at least one of composing, storing, decomposing and directing images in the computer.

12. The system of claim 9, wherein each of the two images is generated from a video recording of the subject.

13. The system of claim 9, wherein each of the two images is technically generated.

14. The system of claim 9, wherein the image composed from the original two images is stored with additional information including at least one of position from which the images are captured, and the time when the capture occurred.

15. The system of claim 10, wherein each of the two images is generated from a video recording of the subject.

16. The system of claim 11, wherein each of the two images is generated from a video recording of the subject.

17. The system of claim 10, wherein each of the two images is technically generated.

18. The system of claim 11, wherein each of the two images is technically generated.

19. The system of claim 8, wherein the system is at least one of an active stereoscopic system and a passive stereoscopic system.

20. The system of claim 8, wherein the system stereoscopically represents sequenced image pairs.

21. The system of claim 20, wherein the sequenced image pairs are at least one of static, rate filled and real timed pairs.

22. A method of stereoscopically representing a subject, comprising the steps of:
capturing two images of the subject from two different positions; and
directing the two images to two outputs of a graphic card of a computer.

23. The method of claim 22, further comprising the steps of:
composing the two images in a single image;
electronically storing the composed image;
decomposing to the two original images; and
directing the decomposed images to the two outputs of the graphic card.
